(19) United States
(12) Patent Application Publication
(10) Pub. No.: US 2022/0402294 A1
(43) Pub. Date: Dec. 22, 2022

(54) IMAGE ENGRAVING APPARATUS AND ENGRAVING HEAD

(71) Applicant: Sekise Corporation, Tokyo (JP)

(72) Inventor: Yuichi HOSHIYAMA, Tokyo (JP)

(21) Appl. No.: 17/749,277

(22) Filed: May 20, 2022

(30) Foreign Application Priority Data
Jun. 16, 2021 (JP) 2021-099913

(51) Int. Cl. B44B 3/00; B44B 3/06; B06B 1/06; B41C 1/04

(52) U.S. Cl. CPC B44B 3/005; B44B 3/063; B06B 1/0611; B41C 1/04

(57) ABSTRACT

The present invention provides an image engraving apparatus capable of precisely driving a stylus to improve accuracy of image engraving. The image engraving apparatus has a vibration actuator fixed to a floating base and having an output portion configured to output vibration generated by deformation of piezoelectric elements, a stylus supported with a stylus holder to be vibrated and engrave an image on a medium to be engraved, a supporting spring supporting the stylus holder, and a retainer positionally adjustably supported to the floating base to come into contact with the medium.

### BACKGROUND OF THE INVENTION

### 1. Field of the Invention

The present invention relates to an image engraving apparatus and an engraving head to easily conduct to engrave an image with high accuracy using a vibration actuator with piezo electric elements when particularly engraving image information such as a face photo, a finger print and a signature to a medium to be engraved, the medium being a booklet such as a passport, a monoplane sheet (paper) such as a graduation certificate or a certificate of commendation, a card or the like.

### 2. Description of the Related Art

Conventionally, there is an image engraving apparatus for engraving an image on a medium to be engraved, the medium having a booklet shape like a passport, a sheet shape, a card shape or the like. The image engraved prevents falsification or provides an additional aesthetic value. Such an image engraving apparatus is disclosed in JP 2006-289823 A or JP 5209345 B.

The image engraving apparatus vibrates a stylus based on an image signal which is an electric signal converted from image data and performs fine engraving with the vibrating stylus. This forms an image corresponding to the image data of a photograph, an illustration or the like on the medium to be engraved.

The image engraving apparatus has an electromagnet and a permanent magnet as an actuator. The permanent magnet is attached to a base and a movable piece supported with springs are vibrated to apply vibration to the stylus.

When the movable piece is vibrated to drive the stylus to engrave an image, it is important to make the movable piece reliably follow the image signal to accurately drive the stylus.

The movable piece is, however, supported with the springs to the base at a neutral position within a gap relative to the permanent magnet. With this, the springs urge the movable piece to return to the neutral position at the time of the vibration. Accordingly, the vibration remains due to urging force even after stopping energization to the electromagnet to limit on improvement of accuracy of the image engraving.

### SUMMARY OF THE INVENTION

An object of the present invention is to further precisely drive a stylus to allow accuracy of image engraving to be improved.

In order to accomplish the object, a first aspect of the present invention provides an image engraving apparatus. The image engraving apparatus has a floating base elastically supported, a vibration actuator fixed to the floating base and including an output portion and stacked piezoelectric elements, the output portion configured to output vibration generated by deformation of the piezoelectric elements, a stylus holder connected to the output portion to receive the vibration, a stylus supported with the stylus holder to be vibrated according to the vibration received by the stylus holder and engrave an image on a medium to be engraved, a supporting spring supporting the stylus holder to the floating base to allow the stylus holder to be vibrated when the stylus holder receives the vibration, and a retainer positionally adjustably supported to the floating base to come into contact with the medium to be engraved and position the stylus relatively to the medium to be engraved, wherein relative movement between the stylus vibrated and the medium to be engraved is caused based on an image signal to engrave an image on the medium to be engraved.

A second aspect of the present invention provides an engraving head for the image engraving apparatus.

According to the present invention, energization to the vibration actuator is performed to engrave an image on a medium to be engraved according to relative movement between the stylus vibrated and the medium based on an image signal.

Further, the vibration actuator outputs vibration according to deformation of the stacked piezoelectric elements without interfere of the spring to precisely drive the stylus according to the image signal. This improves accuracy of image engraving.

### BRIEF DESCRIPTION OF THE DRAWINGS

FIG. 1 is a perspective view partly illustrating an image engraving apparatus according to an embodiment of the present invention;

FIG. 2 is a perspective view partly illustrating an engraving head of the image engraving apparatus of FIG. 1;

FIG. 3 is a perspective view partly illustrating the engraving head viewed from another angle;

FIG. 4 is a perspective view partly illustrating the engraving head without a suction duct and the like viewed from still another angle;

FIG. 5 is a plan view partly illustrating the engraving head;

FIG. 6 is a right side view partly illustrating the engraving head;

FIG. 7 is a schematic sectional view illustrating the engraving head of FIG. 6 at a cutting plane orthogonal to a left-right direction;

FIG. 8 is a schematic sectional view illustrating the engraving head of FIG. 6 at a cutting plane orthogonal to a front-back direction;

FIG. 9 is a perspective view illustrating a relation between vibration actuators and a stylus of the engraving head;

FIG. 10 is a perspective view illustrating a relation among a stylus holder, the stylus and a supporting spring of the engraving head;

FIG. 11 is a perspective view illustrating the supporting spring of FIG. 10;

FIG. 12 is a conceptual view illustrating a circuit based on a double actuator system including the two vibration actuators according to the embodiment;

FIG. 13 is a conceptual view illustrating vibration of the stylus and an engraving direction according to the double actuator system of FIG. 12;

FIG. 14 is a conceptual view illustrating a circuit based on a double actuator system including two vibration actuators according to a reference example;

FIG. 15 is a side view illustrating the vibration actuator without one of brackets according to the reference example;

FIG. 16A is a pattern diagram illustrating resolution of an engraved image formed by a single actuator system according to a reference example;

FIG. 16B is a pattern diagram illustrating resolution of an engraved image formed by the double actuator system according to the reference example;

FIG. 17A is a pattern diagram illustrating an engraved image formed by the single actuator system according to the reference example;

FIG. 17B is a pattern diagram illustrating an engraved image formed by the double actuator system according to the reference example;

FIG. 18 is a table illustrating dot images and engraved images according to the single and the double actuator systems according to the reference examples;

FIG. 19 is a table illustrating assignment of signals of an adder circuit and a subtraction circuit;

FIG. 20A is a table for explaining signal diagrams in FIG. 19;

FIG. 20B is a table for explaining engraved diagrams corresponding to the signal diagrams in FIG. 19;

FIG. 21 is a graph illustrating characteristics indicated by triangular waves of a result of a vibration test conducted to a single vibration actuator according to the reference example;

FIG. 22 is a graph illustrating characteristics indicated by burst waves of the result of the vibration test conducted to the single vibration actuator according to the reference example;

FIG. 23 is a graph illustrating hysteresis characteristics of the result of the vibration test conducted to the single vibration actuator according to the reference example; and

FIG. 24 is a graph illustrating resonance characteristics of the result of the vibration test conducted to the single vibration actuator according to the reference example.

### DETAILED DESCRIPTION OF EMBODIMENTS

An embodiment according to the present invention will be explained. The embodiment provides an image engraving apparatus and an engraving head, capable of precisely driving a stylus to improve accuracy of image engraving. The image engraving apparatus includes a floating base, a vibration actuator, a stylus holder, a stylus, a supporting spring and a retainer. The floating base is elastically supported. The vibration actuator is fixed to the floating base and includes an output portion and stacked piezoelectric elements. The output portion is configured to output vibration generated by deformation of the piezoelectric elements. The stylus holder is connected to the output portion to receive the vibration. The stylus is supported with the stylus holder to be vibrated according to the vibration received by the stylus holder and engrave an image on a medium to be engraved. The supporting spring supports the stylus holder to the floating base to allow the stylus holder to be vibrated when the stylus holder receives the vibration. The retainer is positionally adjustably supported to the floating base to come into contact with the medium to be engraved and position the stylus relatively to the medium to be engraved. Relative movement between the stylus vibrated and the medium to be engraved is caused based on an image signal to engrave an image on the medium to be engraved.

The vibration actuator may have an optional stacked form of the piezoelectric elements and an optional shape of each piezoelectric element as long as the output portion is provided for the vibration generated by the deformation of the piezoelectric elements.

The vibration actuator may employ a single actuator system or a double actuator system. The single actuator system outputs vibration any one of an X-axis direction, a Y-axis direction and a Z-axis direction. The double actuator system outputs vibration two of the X-axis direction, the Y-axis direction and the Z-axis direction.

The stylus holder may be connected to the output portion of the vibration actuator through, for example, a piano wire. The stylus holder should receive the vibration output from the vibration actuator. The connecting member between the output portion and the stylus holder and the connecting form are optional.

The supporting spring may be a bar-shaped spring, a plate spring or the like as long as the stylus holder is supported to the floating base and is allowed to be vibrated.

The retainer may be positionally adjustably supported to a head base fixed and supported to the floating base through an adjuster with an adjusting dial. The retainer may be positionally adjustably supported to the floating base as well as the stylus.

The retainer may be made of hard metal alloy or the like. The material and shape of the retainer is optional as long as the retainer comes into contact with the medium to be engraved to position the stylus to the medium.

The floating base may be elastically supported in the Z-axis direction. The vibration actuator may include a Z-axis vibration actuator and a Y-axis vibration actuator. The Z-axis vibration actuator has a Z-axis output portion to output vibration in the Z-axis direction. The Y-axis vibration actuator has a Y-axis output portion to output vibration in the Y-axis direction. The stylus holder may be connected to the Z-axis output portion and the Y-axis output portion to receive the vibrations in the Z-axis direction and the Y-axis direction. The supporting spring may include a Z-axis spring portion and a Y-axis spring portion to support the stylus holder to the floating base. The Z-axis spring portion allows the stylus holder to be vibrated in the Z-axis direction and the Y-axis spring portion allows the stylus holder to be vibrated in the Y-axis direction.

An engraving head to realize the image engraving apparatus includes a head frame, the floating base, the Z-axis vibration actuator, the Y-axis vibration actuator, the stylus holder, the stylus, the supporting spring and the retainer. The head frame is supported on an apparatus body through a Z-axis driving mechanism to vertically move in the Z-axis direction. The floating base is elastically supported to the head frame in the Z-axis direction. The Z-axis vibration actuator is fixed to the floating base and has the Z-axis output portion and the stacked piezoelectric elements. The Z-axis output portion is configured to output vibration generated by deformation of the piezoelectric elements of the Z-axis vibration actuator in the Z-axis direction. The Y-axis vibration actuator is fixed to the floating base and has the Y-axis output portion and the stacked piezoelectric elements. The Y-axis output portion is configured to output vibration generated by deformation of the piezoelectric elements of the Y-axis vibration actuator in the Y-axis direction. The stylus holder is connected to the Z-axis output portion and the Y-axis output portion to receive the vibrations in the Z-axis direction and the Y-axis direction. The stylus is supported with the stylus holder to be vibrated according to the vibration received by the stylus holder and engrave an image on a medium to be engraved. The supporting spring supports the stylus holder to the floating base and including the Z-axis spring portion to allow the stylus holder to be vibrated in the Z-axis direction when the stylus holder receives the vibration in the Z-axis direction and the Y-axis spring portion to allow the stylus holder to be vibrated in the Y-axis direction when the stylus holder receives the vibration in the Y-axis direction. The retainer is positionally adjustably supported to the floating base to come into contact with the medium to be engraved and position the stylus relatively to the medium to be engraved. Relative movement between the stylus vibrated and the medium to be engraved is caused based on an image signal to engrave an image on the medium to be engraved.

The floating base may be supported by plate springs, coil springs or the like.

The supporting spring may be formed in a single body, the Z-axis spring portion is connected to the stylus holder, and the Y-axis spring portion is connected to the floating base. The Z-axis spring portion and the Y-axis spring portion may be, however, formed as separated bodies connected to each other to form the supporting spring.

The Z-axis vibration actuator may be formed into a flat shape along the Z-axis direction, the Y-axis vibration actuator may be formed into a flat shape along the Y-axis direction, and the Z-axis and the Y-axis vibration actuators may be fixed to the floating base through positioning brackets, respectively.

The positioning brackets may have various shapes as long as the positioning brackets fixes and positions the Z-axis and the Y-axis vibration actuators to the floating base.

Hereinafter, the embodiment of the present invention will be explained in detail with reference to drawings.

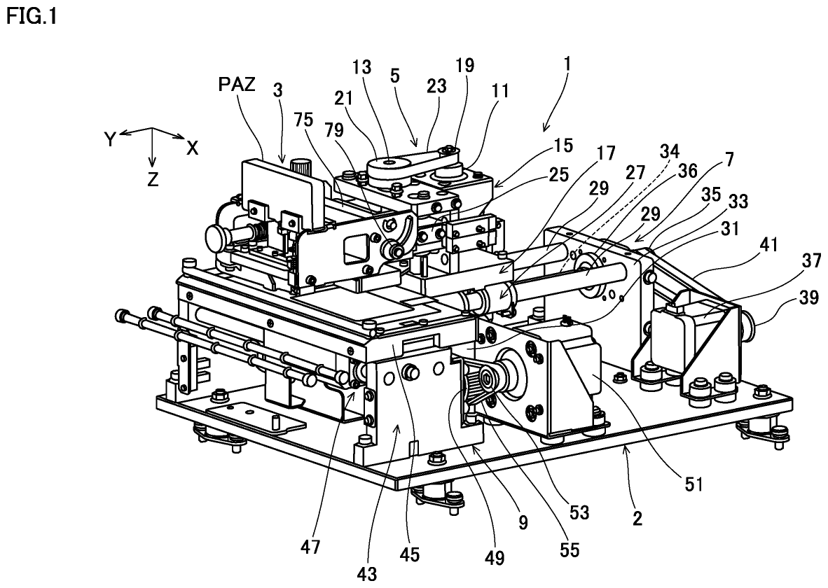

FIG. 1 is a perspective view partly illustrating an image engraving apparatus according to the embodiment of the present invention. In addition, a-Z-axis direction in FIG. 1 is a direction along which a stylus is vibrated for engraving, a Y-axis direction in FIG. 1 is a direction (column direction) orthogonal to a direction (row direction) along which the engraving is advanced, and an X-axis direction is the direction along which engraving is advanced. Further, a front-back direction and a left-right direction are of when the image engraving apparatus is viewed from the front in the Y-axis direction. An up-and-down direction is the Z-axis direction. Directions of an X-axis, a Y-axis and a Z-axis may be altered according to an arrangement of the apparatus. For example, the X-axis may be in the up-and-down direction, the Y-axis in the front-back direction and the Z-axis in the left-right direction. The X-axis may be in the column direction and the Y-axis in the row direction.

As illustrated in FIG. 1, the image engraving apparatus 1 is provided with an engraving head 3 to which a stylus is attached. The stylus is an engraving needle that vibrates according to an input image signal to engrave an image on a medium to be engraved. As the medium to be engraved, there are a card made of synthetic paper or the like, a driver's license, a diploma, a passport and the like. According to the embodiment, the medium is a card.

The image engraving apparatus 1 is further provided with a base 2, a Z-axis driver 5, a Y-axis driver 7 and an X-axis driver 9. The Z-axis driver 5, the Y-axis driver and the X-axis driver 9 are arranged on the base 2.

The Z-axis driver 5 is provided with a Z-axis stepping motor 11, a Z-axis feeding screw 13, a Z-axis base 15 and an elevation base 25.

The Z-axis stepping motor 11 is supported on a rear part of the Z-axis base 15. The Z-axis feeding screw 13 is supported on a front part of the Z-axis base 15. The Z-axis base 15 is fixed to the Y-axis table 17 through brackets or the like. The Z-axis stepping motor 11 and the Z-axis feeding screw 13 are provided with timing pulleys 19 and 21, respectively. A timing belt 23 is wound around the timing pulleys 19 and 21. The timing pulleys 19 and 21 and the timing belt 23 forms the belt driver. Another driver such as meshing gears may be employed instead of the belt driver. The elevation base 25 is screwed with the Z-axis feeding screw 13. A rear part of the engraving head 3 is fixed to the elevation base 25.

The Z-axis stepping motor 11 is driven to rotate the Z-axis feeding screw 13 through the timing pulley 19, the timing belt 23 and the timing pulley 21, so that the elevation base 25 moves upward or downward to move the engraving head 3 in the Z-axis direction.

The Y-axis driver 7 is provided with the Y-axis table 17, a Y-axis feeding screw 34 and a Y-axis stepping motor 37. The Y-axis table 17 includes paired moving blocks 27 fixed to the Y-axis table 17 in the X-axis direction. In FIG. 1, only one of the moving blocks 27 is appeared. The moving blocks 27 are, for example, linear bushes engaging with shafts 29 that are parallel to each other in the X-axis direction and extend in the Y-axis direction to move along the shafts 29 in the Y-axis direction. The shafts 29 are fixed and supported to an intermediate wall 31 and a rear wall 33. The intermediate wall 31 and the rear wall 33 is fixed to the base 2.

The Y-axis feeding screw 34 is a ball screw and is arranged between the intermediate wall 31 and the rear wall 33 in the Y-axis direction, between the shafts 29 in the X-axis direction and slightly below the shafts 29 in the Z-axis direction. The Y-axis feeding screw 34 is rotatably supported with the intermediate wall 31 and the rear wall 33 through bearings. In FIG. 1, only a bearing 36 on the rear wall 33 is illustrated and the bearing on the intermediate wall 31 is not illustrated. A ball socket (not illustrated) engages with the Y-axis feeding screw 34 and is fixed to a lower face of the Y-axis table 17 between the moving blocks 27.

The Y-axis feeding screw 34 passes through the rear wall 33. A timing pulley 35 is supported on the rear wall 33 and is connected to the Y-axis feeding screw 34. The Y-axis stepping motor 37 is arranged on one side of the rear wall 33 and is fixed on the base 2. The Y-axis stepping motor 37 is provided with a timing pulley 39. A timing belt 41 is wound around the timing pulleys 35 and 39 to form a belt driver. Another driver such as meshing gears may be employed instead of the belt driver.

The Y-axis stepping motor 37 is driven to rotate the Y-axis feeding screw 34 through the timing pulley 35, the timing belt 41 and the timing pulley 39, so that the ball socket on the lower face of the Y-axis table 17 moves along the Y-axis feeding screw 34 to move the engraving head 3 through the Y-axis table 17, the Z-axis base 15 and the elevation base 25 in the Y-axis direction.

When moving the Y-axis table 17, the moving blocks 27 are guided by the shafts 29.

The X-axis driver 9 is provided with an X-axis base 43, an X-axis table 45 and an X-axis stepping motor 51. The X-axis base 43 is fixed on the base 2. The X-axis table 45 is arranged on the X-axis base 43. The X-axis table 45 is to support a card. The X-axis table 45 is movable in the X-axis direction. The X-axis base 43 is provided with a reciprocating drive mechanism 47. The reciprocating drive mechanism 47 is connected to the X-axis table 45 and a timing pulley 49. The timing pulley 49 is arranged behind the X-axis base 43. The X-axis stepping motor 51 is arranged behind the X-axis base 43 adjacent to the intermediate wall 31 and is fixed on the base 2. The X-axis stepping motor 51 is provided with a timing pulley 53. A timing belt 55 is wound around the timing pulleys 49 and 53 to form a belt driver. Another driver such as meshing gears may be employed instead of the belt driver.

The X-axis stepping motor 51 is driven to operate the reciprocating drive mechanism 47 through the timing pulley 53, the timing belt 55 and the timing pulley 49, so that the X-axis table 45 reciprocatingly moves in the X-axis direction.

Then, the stylus on the engraving head 3 is controlled based on an image signal to be vibrated and move relatively to a card on the X-axis table 45 in the X-axis, the Y-axis and the Z-axis directions according to the Z-axis stepping motor 11, the Y-axis stepping motor 37 and the X-axis stepping motor 51. With this relative movement, an image is engraved on the card. The image signal is an analog signal converted from an electric signal obtained by scanning an image such as a picture image.

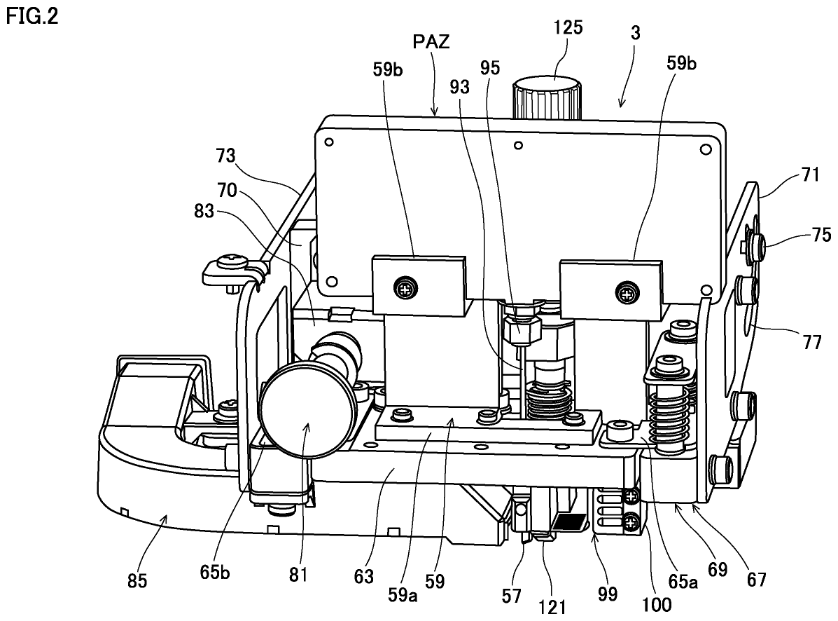

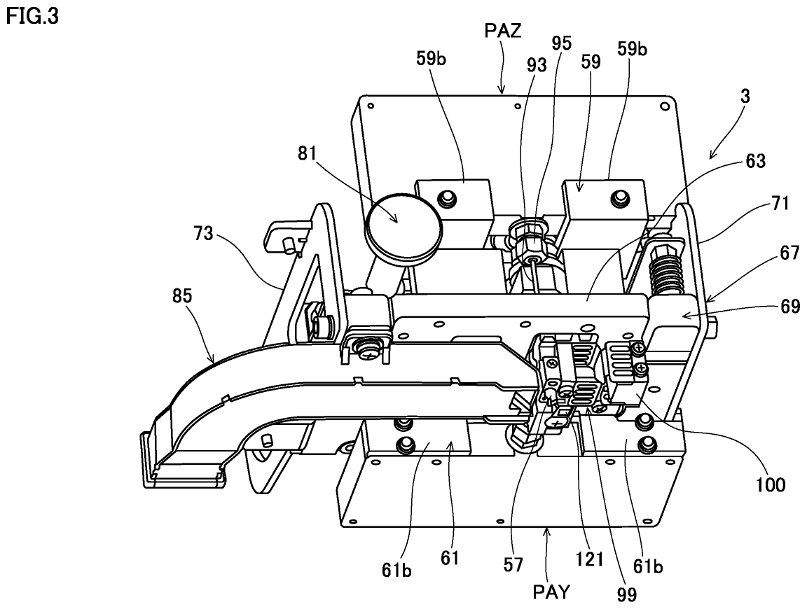

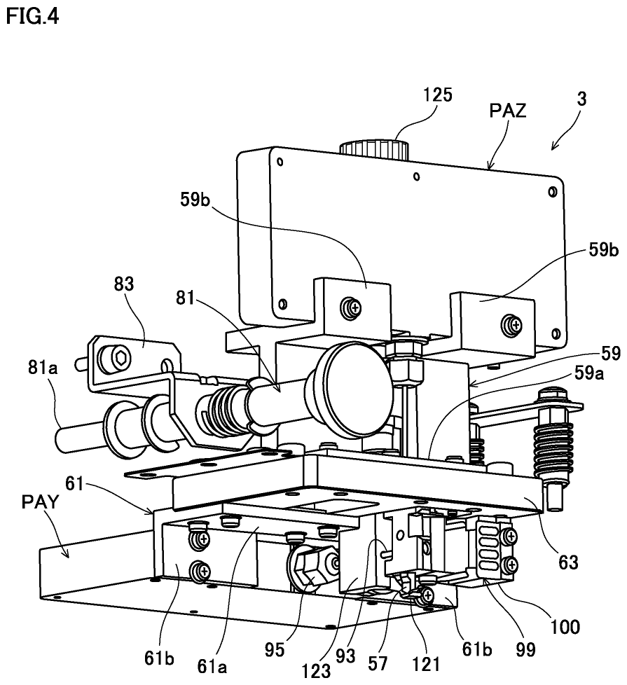

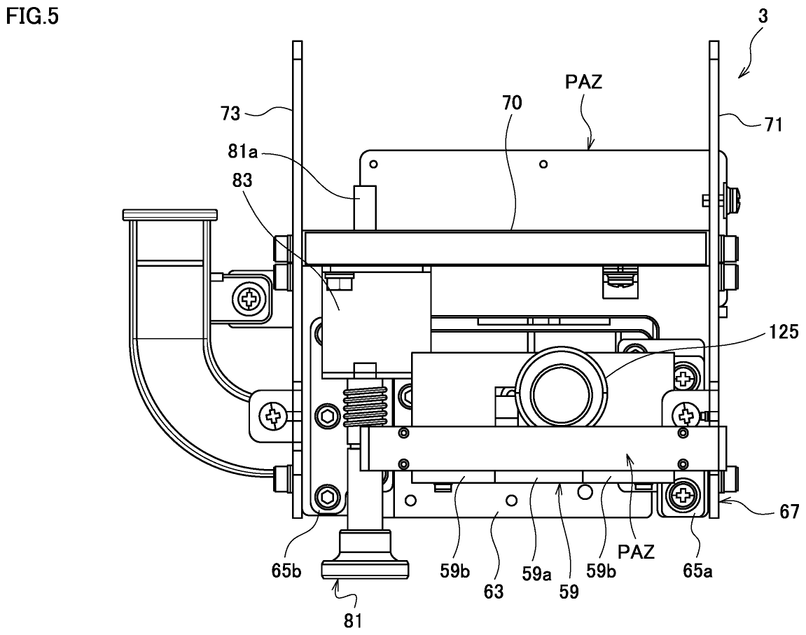

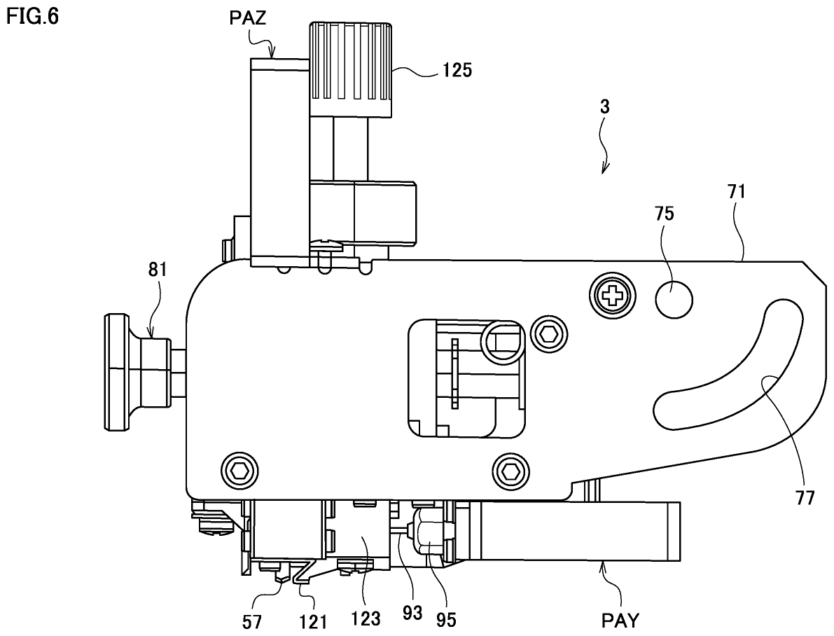

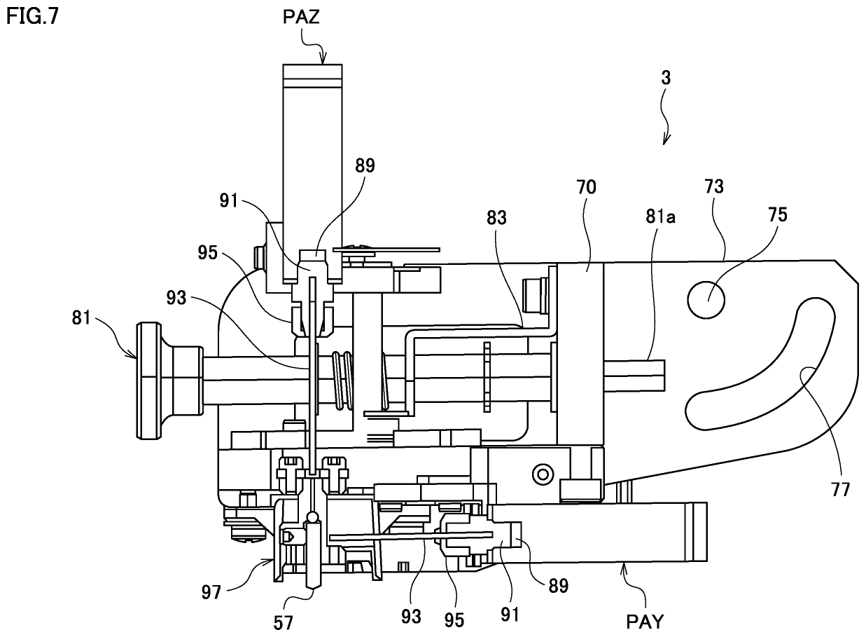

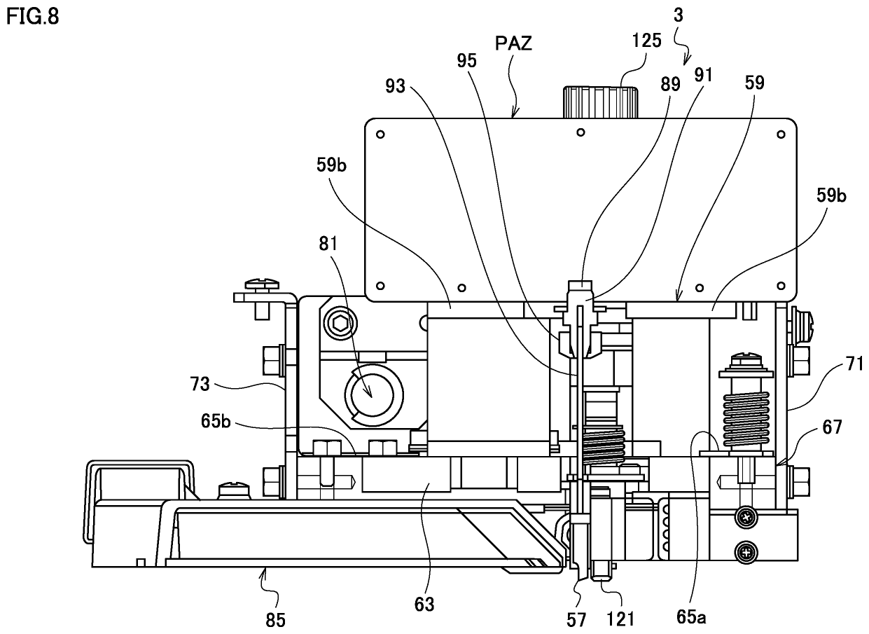

FIG. 2 is a perspective view partly illustrating the engraving head 3 of the image engraving apparatus 1 of FIG. 1. FIG. 3 is a perspective view partly illustrating the engraving head 3 viewed from another angle. FIG. 4 is a perspective view partly illustrating the engraving head 3 without a suction duct and the like viewed from still another angle. FIG. 5 is a plan view partly illustrating the engraving head 3 of the image engraving apparatus 1 of FIG. 1. FIG. 6 is a right side view partly illustrating the engraving head 1 of FIG. 5. FIG. 7 is a schematic sectional view illustrating the engraving head 1 of FIG. 6 at a cutting plane orthogonal to the left-right direction. FIG. 8 is a schematic sectional view illustrating the engraving head 3 of FIG. 6 at a cutting plane orthogonal to the front-back direction.

As illustrated in FIGS. 1-8, the engraving head 3 of the image engraving apparatus 1 is provided with two vibration actuators PAZ and PAY as well as a stylus 57.

The vibration actuators PAZ and PAY are set so as to output vibration in the Z-axis direction from one vibration actuator PAZ and output vibration in the Y-axis direction from the other vibration actuator PAY.

The vibration actuator PAZ is a Z-axis vibration actuator formed into a flat shape along the Z-axis direction and the vibration actuator PAY is a Y-axis vibration actuator formed into a flat shape along the Y-axis direction.

The vibration actuators PAZ and PAY are positioned and fixed to a floating base 63 through positioning brackets 59 and 61, respectively.

The positioning bracket 59 is provided with a base piece 59a and paired fixing pieces 59b. The base piece 59a has a L-shaped sectional shape and each fixing pieces 59b has a L-shaped sectional shape. The base piece 59a of the positioning bracket 59 is fastened and fixed to the floating base 63 with screws. The vibration actuator PAZ is raised in the Z-axis direction, is positioned on the fixing pieces 59b in the Z-axis direction and the Y-axis direction and is fastened and fixed on the fixing pieces 59b at a lower part with screws.

The positioning bracket 61 is provided with base pieces 61a and paired fixing pieces 61b. The base pieces 61a have a flat shape. The fixing pieces 61 have a flat shape and are arranged so as to form a L-shaped sectional shape together with the base pieces 61a, respectively. The base pieces 61a of the positioning bracket 61 are fastened and fixed to the lower face of the floating base 63 with screws. The vibration actuator PAY is arranged along the Y-axis direction, is positioned in the Y-axis direction and the Z-axis direction by bringing a side of the vibration actuator PAY into contact with the fixing pieces 61b and is fastened and fixed to the fixing pieces 61b with screws.

The floating base 63 has a flat shape and is horizontally arranged along an XY-plane. The floating base 63 is elastically supported in the Z-axis direction. The elastically supporting of the floating base 63 is conducted to a head base 67 as a head frame by plate springs 65a and 65b, for example.

The head base 67 is supported by the base 2 as an apparatus body through the Z-axis driver 5 as a Z-axis driving mechanism. The head base 67 is provided with a base frame 69, a rear wall 70 and right and left side walls 71 and 73 to form the head frame of the engraving head 3.

The base frame 69 is formed into a shape facing right and left portions and a rear portion of the floating base 63. The rear wall 70 is raised at a rear portion of the base frame 69. The plate springs 65a and 65b are fixed to the right and left portions of the base frame 69. The right and left portions of the floating base 63 are elastically supported by the plate springs 65a and 65b.

The right and left side walls 71 and 73 are arranged and fixed on both right and left sides of the base frame 69. The side walls 71 and 73 have rear portions protruding rearward relatively to the rear wall 70 of the base frame 69. The rear portions of the side walls 71 and 73 are pivotally supported on a front portion side of the Z-axis base 15 through the head supporting shaft 75 (see FIG. 1). Accordingly, the engraving head 3 is upward pivotally movable around the head supporting shaft 75. The pivotally moving of the engraving head 3 allows the stylus 57 to be easily adjusted, replaced and the like. The side walls 71 and 73 have arc-shaped holes 77. The arch-shaped holes 77 allows the engraving head 3 to be adjusted in position relative to the Z-axis base 15 and the engraving head 3 is fixed to the Z-axis base 15 at an adjusted position with a fastening screw 79 (see FIG. 1).

A screw shaft 81 is supported with a bracket 83 to the head base 67. The fastening screw 79 and the screw shaft 81 are fastened when the engraving head 3 is returned to an engraving position. A front end 81a of the fastened screw shaft 81 is brought into contact with the Z-axis base 15 to position the engraving head 3 with respect to the Z-axis base 15.

A suction duct 85 is attached to the base frame 69. The suction duct 85 has a suction opening arranged close to the stylus 57 under the floating base 63.

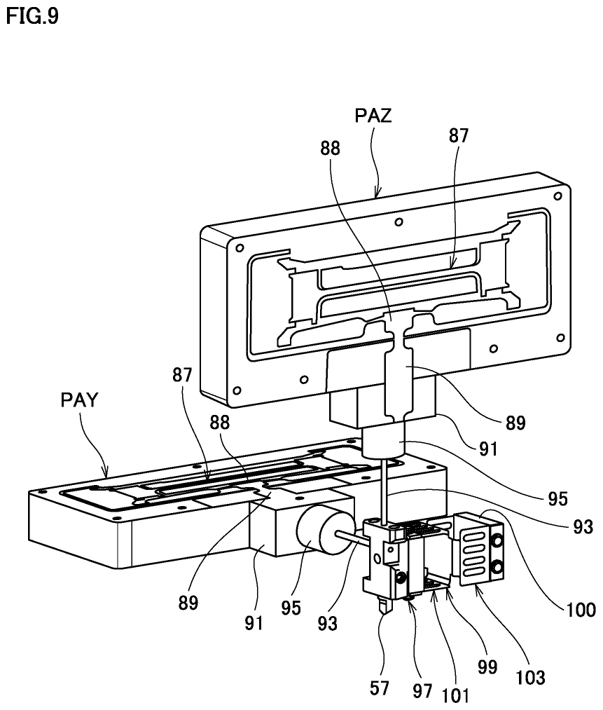

FIG. 9 is a perspective view illustrating a relation between the vibration actuators PAZ and PAY and the stylus 57 of the engraving head 3.

As illustrated in FIG. 9, the vibration actuators PAZ and PAY have the same structure and each of the vibration actuators PAZ and PAY includes stacked piezoelectric elements 87 and an output portion 89. The piezoelectric elements 87 generate vibration according to their own deformation and the output portion 89 outputs the vibration generated by the piezoelectric elements 87. As each of the vibration actuators PAZ and PAY, a piezo-actuator (MTKK10S300F120PS) manufactured by Mechano Transformer Corporation (2-7-12, Iwamotocho, Chiyoda-ku, Tokyo) is used for example. The vibration actuators PAZ and PAY may, however, employ various actuators configured to output vibration generated by deformation of stacked piezoelectric elements.

Each of the vibration actuators PAZ and PAY according to the embodiment includes an amplification mechanism 88 to amplify the deformation generated by the piezoelectric elements 87 to several to several tens of times. The amplified vibration is output from the output portion 89. The output portion 89 is arranged at a center in the X-axis direction on a side of each of the vibration actuators PAZ and PAY.

As illustrated in FIGS. 7-9, the output portion 89 has a front end to which a supporting block 91 is attached. The supporting block 91 has an insertion hole for a connecting member 93 at an axial center. The connecting member 93 has a linear shape, one end of which is inserted into the supporting block 91 through the insertion hole. The connecting member 93 is a piano wire, for example. The supporting block 91 has a front end to which a chuck 95 is fastened. The chuck 95 fixes the connecting member 93 inserted into the supporting block 91.

The connecting member 93 of the vibration actuator PAZ is extended in the Z-axis direction and the connecting member 93 of the vibration actuator PAY is extended in the Y-axis direction. The other end of each connecting member 93 is connected to a stylus holder 97. The stylus holder 97 is, therefore, connected to the output portions 89 through the connecting members 93 in the Z-axis direction and the Y-axis direction in order to receive the vibrations.

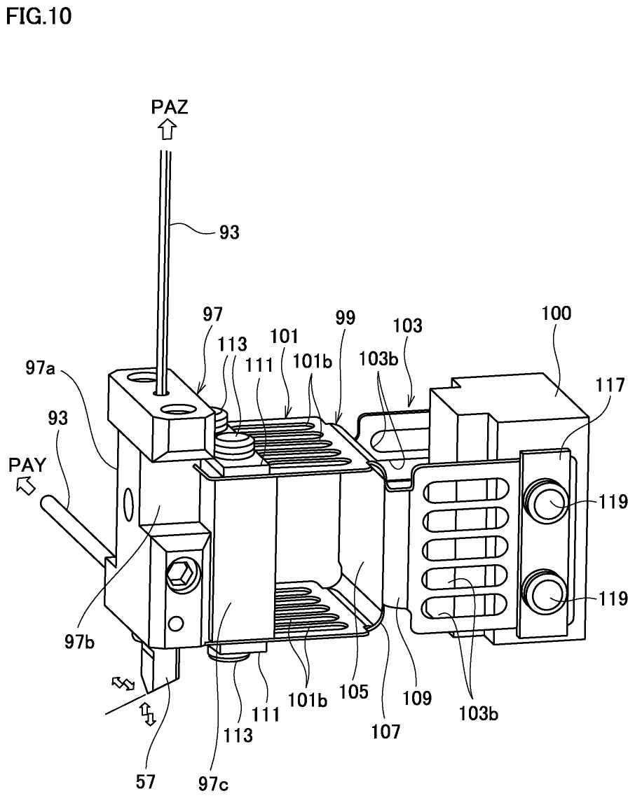

FIG. 10 is a perspective view illustrating a relation among the stylus holder 97 and the stylus 57 and a supporting spring 99 of the engraving head 1 of FIG. 5.

The stylus holder 97 is made of extra-super duralumin A7075 or the like into a block shape. The stylus holder 97 has a basic shape symmetric in the Y-axis direction. The stylus holder 97 has a relatively large recessed portion 97a and a relatively small recessed portion 97b. The recessed portion 97a is vertically extended to have a vertical center that is arranged at a vertical center of a face of the basic shape facing the vibration actuator PAY in the Y-axis direction. The recessed portion 97b is vertically extended to have a vertical center that is arranged over a vertical center of a face of the basic shape opposite to the face on which the recessed portion 97a is formed or the vibration actuator PAY in the Y-axis direction. The stylus holder 97 has an attachment block 97c from a lower portion of a back face to a lower face of the basic shape.

The stylus 57 is supported with the stylus holder 97 to be vibrated according to the vibration received by the stylus holder 97. In particular, the stylus 57 is supported in an attachment hole of the lower face of the stylus holder 97. The lower end (other end) of the connecting member 93 extending in the Z-axis direction is inserted into an attachment hole at a center on an upper face of the stylus holder 97 so that vibration is transmitted from the connecting member 93 to the stylus holder 97. The Y-axis end (other end) of the connecting member 93 extending in the Y-axis direction is inserted into an attachment hole at a lower portion on a side face of the stylus holder 97 so that vibration is transmitted from the connecting member 93 to the stylus holder 97.

The stylus holder 97 supports a front end of the supporting spring 99 with the attachment block 97c. The supporting spring 99 elastically supports the stylus holder 97 to a fixing portion 100 to allow the stylus holder 97 to be vibrated when the stylus holder 97 receives the vibration and guide the stylus holder 97 in a vibrating direction.

FIG. 11 is a perspective view illustrating the supporting spring 99 of FIG. 10.

As illustrated in FIGS. 9-11, the supporting spring 99 is provided with a Z-axis spring portion 101 and a Y-axis spring portion 103. The Z-axis spring portion 101 and the Y-axis spring portion 103 are formed of plate springs being integral with each other in a single body. The supporting spring 99 according to the embodiment has a connecting plate 105. The Z-axis spring portion 101 has plate spring elements connected to vertical ends (upper and lower ends) of the connecting plate 105 through curved resilient portions 107, respectively. The Y-axis spring portion 103 has plate spring elements connected to horizontal ends (right and left ends) of the connecting plate 105 through curved resilient portions 109, respectively. The Z-axis spring portion 101 and the Y-axis spring portion 103 have attachment holes 101a and 103a and slots 101b and 103b. The numbers of the attachment holes 101a and the slots 101b are the same as those of the attachment holes 103a and the slots 103b. The Z-axis spring portion 101 and the Y-axis spring portion 103 have the same shape and are shifted to each other at an angle of 90 degrees relative to the connecting plate 105.

The Z-axis spring portion 101 has the front end connected and fixed to upper and lower faces of the attachment block 97c of the stylus holder 97 through seat plates 111 with screws 113. The Y-axis spring portion 103 has a front end connected and fixed to right and left faces of the fixing portion 100 through seat plates 117 with screws 119. The fixing portion 100 is a projection to which the supporting spring 99 is attached. In the embodiment, the fixing portion is a piece or block fixed to the floating base 63. Namely, the floating base 63 has the fixing portion 100.

In this way, the Z-axis spring portion 101 is arranged so that faces of the plate spring elements are oriented to the Z-axis direction and the Y-axis spring portion 103 is arranged so that faces of the plate spring elements are oriented to the Y-axis direction.

The Z-axis spring portion 101 and the Y-axis spring portion 103 are connected in series between the stylus holder 97 and the fixing portion 100. The Z-axis spring portion 101 allows the stylus holder 97 to be vibrated in the Z-axis direction and the Y-axis spring portion 103 allows the stylus holder 97 to be vibrated in the Y-axis direction.

As illustrated in FIGS. 2, 4, 6 and 8, a retainer leg 121 is arranged so as to be adjacent to the stylus 57. The retainer leg 121 forms a retainer to position the stylus 57 relatively to a card. The retainer leg 121 according to the embodiment comes into contact with a card when, in the Z-axis direction, positioning the stylus 57 to the card supported on the X-axis table 45. The retainer leg 121 is made of, for example, hard metal.

The retainer leg 121 has a base portion supported with a leg block 123 so as to be positionally adjustable in the Z-axis direction. The leg block 123 includes an adjusting screw (not illustrated) to which the base portion of the retainer leg 121 is connected. The adjusting screw of the leg block 123 is connected to an adjusting knob 125 supported on the head base 67.

The adjusting knob 125 is, therefore, rotated to vertically adjust the retainer leg 121 through the adjusting screw.

In addition, the leg block 123 has a through-hole in the Y-axis direction and the connecting member 93 in the Y-axis direction is arranged to pass through the leg block 123.

When engraving an image on a card, the adjusting knob 125 is rotated so as to bring the retainer leg 121 into contact with the card supported on the X-axis table 25. With the contact, the retainer leg 121 receives reaction force from the card so that the floating base 63 slightly retracts against elastic force of the plate springs 65a and 65b upward in the Z-axis direction.

Next, the Z-axis stepping motor 11 drives the Z-axis feeding screw 13 through the timing pulley 19, the timing belt 23 and the timing pulley 21 to descend the elevation base 25. The engraving head 3 as a whole descends in conjunction with the elevation base 25. The descending of the engraving head 3 is performed by a retracting amount of the floating base 63. With this, the stylus 57 is positioned at the engraving position relative to the card.

Next, the stacked piezoelectric elements 87 of each vibration actuator deform to generate vibration according to an image signal and the generated vibration is output and transmitted from the output portion 89 to the stylus holder 97 through the connecting member 93. The stylus holder 97 as well as the stylus 57 is vibrated by the transmitted vibration and moves relatively to the card in the X-axis, the Y-axis and the Z-axis directions to perform engraving on the card based on the image signal.

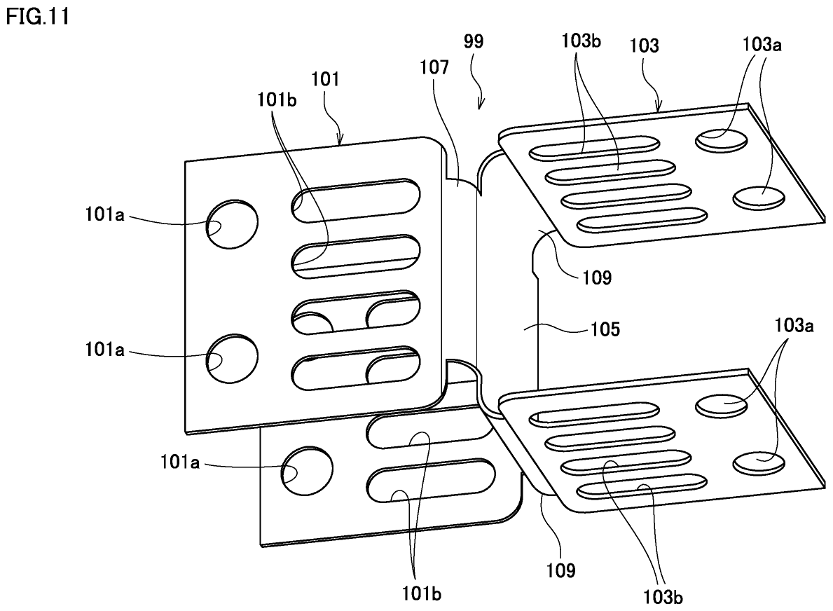

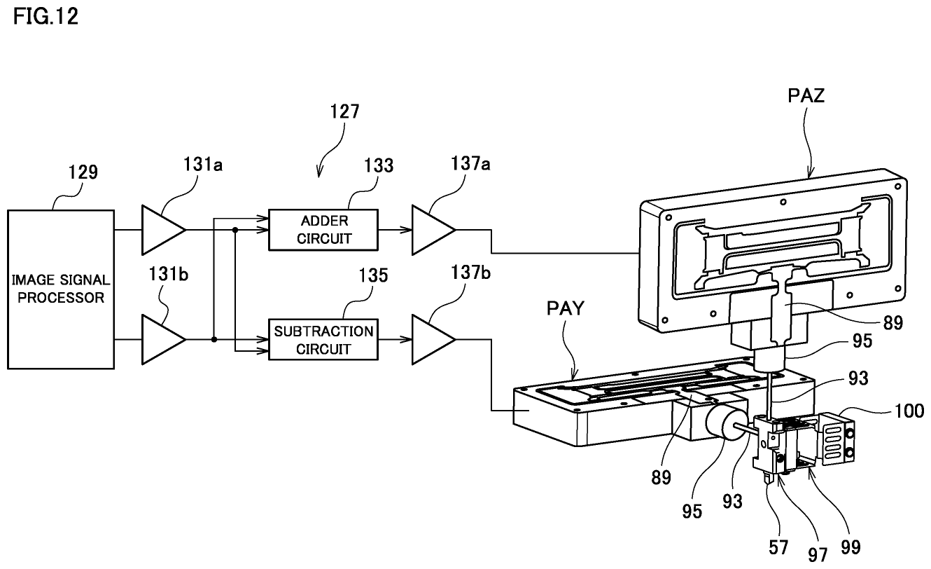

FIG. 12 is a conceptual view illustrating a circuit based on a double actuator system including the two vibration actuators PAZ and PAY according to the embodiment.

The two vibration actuators PAZ and PAY are set so that one of the vibration actuators outputs vibration in the Z-axis direction and the other of the vibration actuators outputs vibration in a direction orthogonal to the Z-axis direction, e.g., the Y-axis direction as mentioned above.

The vibration actuators PAZ and PAY are electrically connected to a drive circuit 127. The drive circuit 127 is conceptually illustrated in FIG. 12 in order to indicate a relation between an image signal processor 129 and the vibration actuators PAZ and PAY. The drive circuit 127 includes the image signal processor 129, paired amplifiers 131a and 131b, an adder circuit 133, a subtraction circuit 135 and amplifiers 137a and 137b.

The image signal processor 129 is electrically connected the amplifiers 131a and 131b so as to input an image signal to the amplifiers 131a and 131b. The amplifiers 131a and 131b are electrically connected to both the adder circuit 133 and the subtraction circuit 135. The adder circuit 133 is electrically connected to the vibration actuator PAZ through the amplifier 137a. The subtraction circuit 135 is electrically connected to the vibration actuator PAY through the amplifier 137b.

Then, current is applied to the vibration actuators PAZ and PAY according to the image signal. The stylus 57 is vibrated in the Z-axis direction according to the vibration output from the output portion 89 of the vibration actuator PAZ and moves relatively to a card in the X-axis, the Y-axis and the Z-axis directions to perform engraving on the card based on the image signal. Relative to the engraving, the vibration actuator PAY adds vibration to the stylus holder 97 in the Y-axis direction based on the image signal.

The double actuator system using the vibration actuators PAZ and PAY performs the engraving with high accuracy.

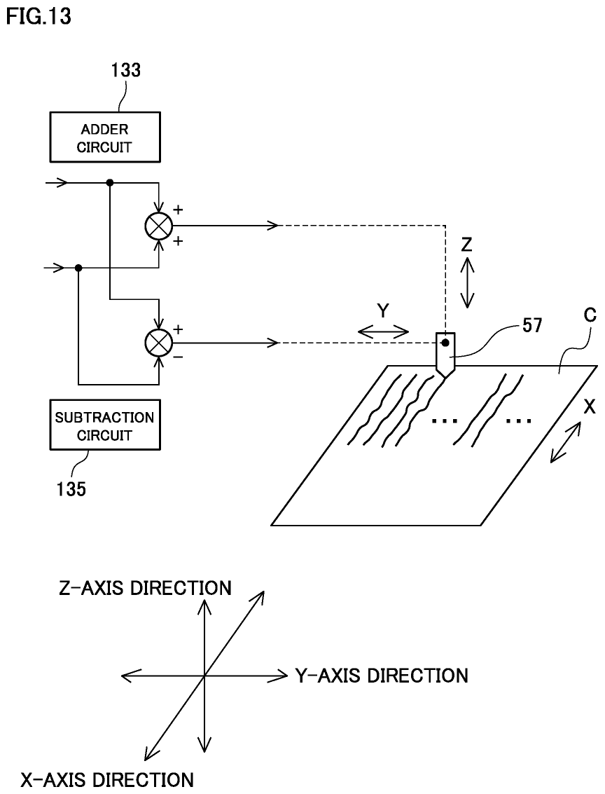

FIG. 13 is a conceptual view illustrating the vibration of the stylus 57 and the engraving direction according to the double actuator system of FIG. 12.

As illustrated in FIG. 13, the vibrations in the Z-axis direction and the Y-axis direction are transmitted from the vibration actuators PAZ and PAY to the stylus 57. The stylus 57 moves relatively to a card C supported on the X-axis table 45 in the X-axis direction according to the movement of the X-axis table 45. The stylus 57 is vibrated in the Z-axis direction according to level of a signal of an image signal output from the adder circuit 133. Further, the stylus 57 is vibrated in the Y-axis direction according to polarity of a subtraction signal of the image signal output from the subtraction circuit 135, the Y-axis direction being a direction orthogonal to an engraving line that is a reference line along the card C. When the stylus 57 is deviated from the engraving line according to the vibration in the Y-axis direction, the stylus 57 is positioned on a vibration position and performs engraving corresponding to amplitude of the vibration in the Z-axis direction at the vibration position.

When a face photo image is engraved by an image engraving apparatus according to a comparative example having vibration actuators each using a solenoid for example, white remnants of a white background remain on a black hair at a boundary between the white background and the black hair. This fades the hair of the engraved image so as to depart from an original image. Similarly, a face of the engraved image is faded by remnants of the black hair at a boundary between the face and the hair so as to depart from the original image. In this way, the comparative example fades an engraved image at each boundary between light color and deep color so as to depart from an original image.

In contrast, when a face photo image is engraved by the image engraving apparatus 1 having the vibration actuators PAZ and PAY using the piezoelectric elements according to the embodiment, there are almost no remnants at a boundary between a white background and a black hair and at a boundary between a face and the hair.

Namely, the embodiment performs accurately engraving by comparison with the comparative example.

Additionally, the engraved image according to the double vibration actuators PAZ and PAY is more precisely than an engraved image according to a single vibration actuator. This comparison will be explained later.

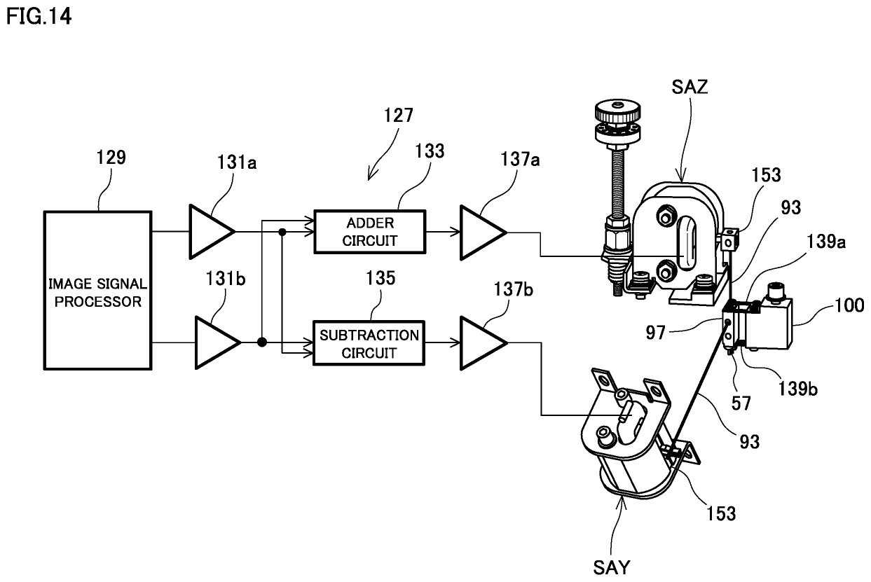

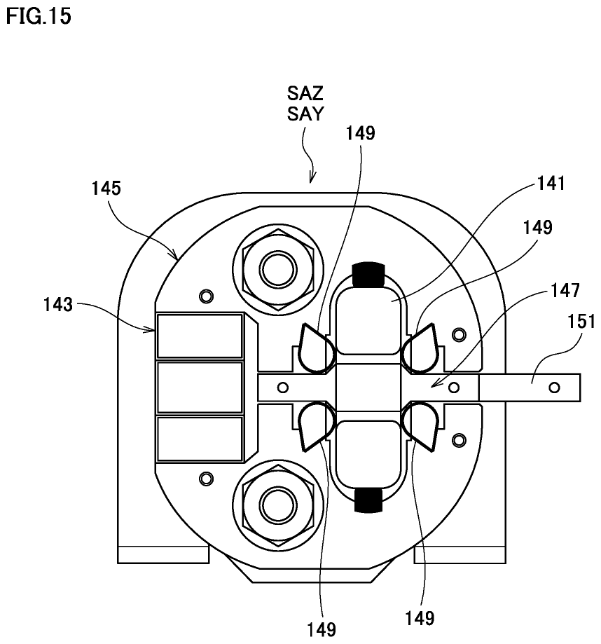

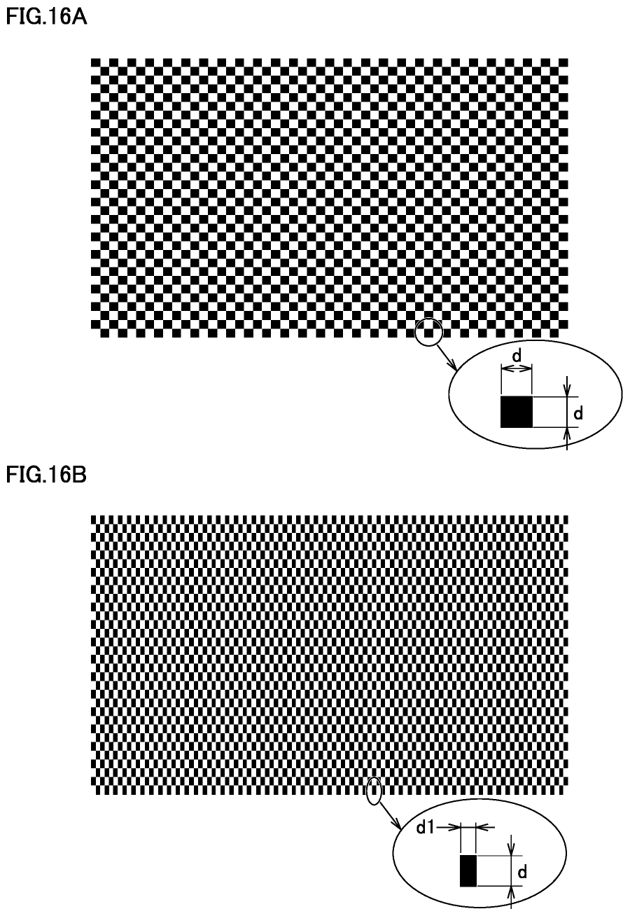

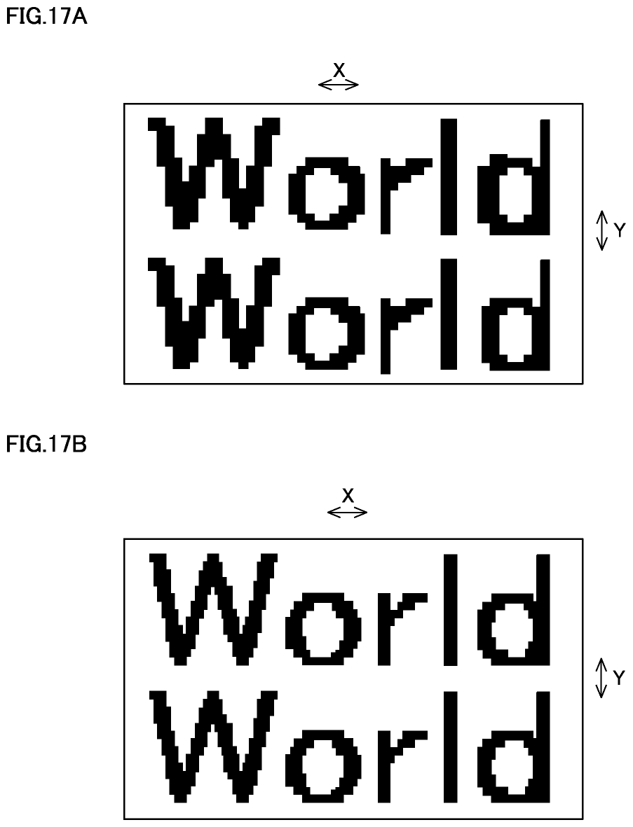

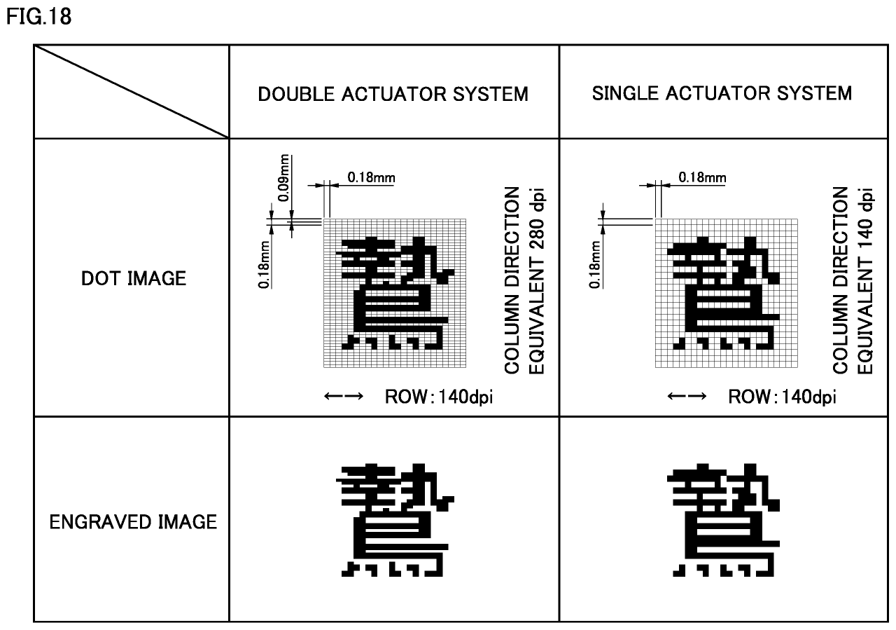

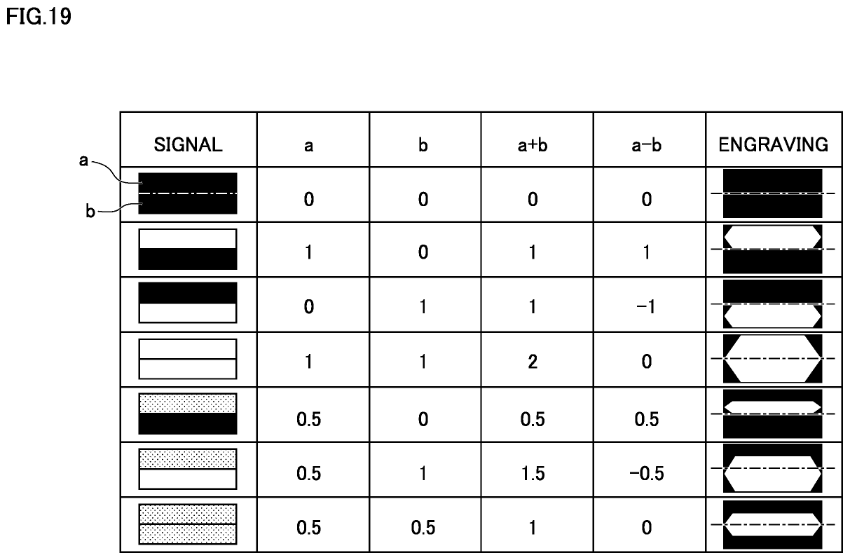

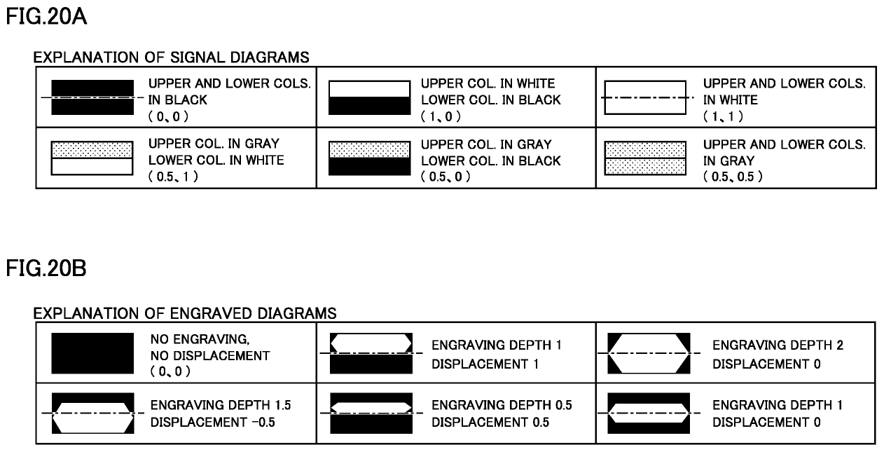

FIG. 14 is a conceptual view illustrating a circuit based on a double actuator system including two vibration actuators according to a reference example. FIG. 15 is a side view illustrating the vibration actuator without one of the brackets according to the reference example. FIG. 16A is a pattern diagram illustrating resolution of an engraved image formed by a single actuator system according to a reference example. FIG. 16B is a pattern diagram illustrating resolution of an engraved image formed by the double actuator system according to the reference example. FIG. 17A is a pattern diagram illustrating an engraved image formed by the single actuator system according to the reference example. FIG. 17B is a pattern diagram illustrating an engraved image formed by the double actuator system according to the reference example. FIG. 18 is a table illustrating dot images and engraved images according to the single and the double actuator systems. FIG. 19 is a table illustrating assignment of signals of an adder circuit and a subtraction circuit. FIG. 20A is a table for explaining signal diagrams in FIG. 19. FIG. 20B is a table for explaining engraved diagrams corresponding to the signal diagrams in FIG. 19.

In the reference example of the double actuator system, vibration actuators SAZ and SAY each using a solenoid are used instead of the vibration actuators PAZ and PAY of FIG. 12. In FIG. 14, components corresponding to of FIG. 12 are represented with the same reference numerals as of FIG. 12 to eliminate repetition in description.

An arrangement of the two vibration actuators SAZ and SAY corresponds to the arrangement of the vibration actuators PAZ and PAY. Namely, the vibration actuator SAZ is set to output vibration in the Z-axis direction and the vibration actuator SAY is set to output vibration in the Y-axis direction.

A stylus holder 97 is connected through connecting members 93 to the vibration actuators SAZ and SAY and is supported at front ends of supporting springs 139a and 139b having a rod shape to allow the stylus holder to be vibrated in the Z-axis and the Y-axis directions.

The vibration actuators SAZ and SAY are connected to a drive circuit 127. Namely, coils 141 of the vibration actuators SAZ and SAY are connected to amplifiers 137a and 137b.

As illustrated in FIG. 15, each of the vibration actuators SAZ and SAY includes a permanent manet 143, a yoke 145, a coil 141 and a movable piece 147. The movable piece 147 is supported to the yoke 145 through four springs 149 to be vibrated relatively to the yoke 145 according to energization to the coil 141. The movable piece 147 integrally has an arm 151. The connecting members 93 are connected through supporting blocks 153 to the arms 151 of the vibration actuators SAZ and SAY, respectively.

Then, the vibration actuators SAZ and SAY are energized according to an image signal. The stylus 57 vibrates in the Z-axis in conjunction with vibration due to seesaw operation of the movable piece 147 of the one vibration actuator SAZ and moves in the X-axis, the Y-axis and the Z-axis directions relatively to a card according to the image signal to perform engraving on the card. To the engraving, the other vibration actuator SAY adds vibration to the stylus holder 97 in the Y-axis direction due to seesaw operation of the movable piece 147 based on the image signal.

The double actuator system using the vibration actuators SAZ and SAY performs precisely engraving compared with a single actuator system using only the vibration actuator SAZ to output vibration in the Z-axis direction.

The single actuator system obtains resolution as illustrated in FIG. 16A. The double actuator system in which the vibration actuator SAY is added to the single actuator system obtains resolution as illustrated in FIG. 16B. Namely, the resolution dl of the double actuator system in the Y-axis direction is twice as much as the resolution d of the single actuator system.

Engraving a wording “World” using the single actuator system, an engraved image is as illustrated in FIG. 17A. Engraving the wording “World” using the double actuator system, an engraved image is as illustrated in FIG. 17B. The double solenoid system obtains precisely engraved image by comparison with the single actuator system.

Similarly, the double actuator system and the single actuator system engrave a Chinese character meaning hawks and eagles as illustrated in FIGS. 18A and 18B, respectively. Comparing the dot images and the engraved images, the double actuator system obtains more precisely images than the single actuator system.

A principle of the resolution of the double actuator system being twice as the resolution of the single actuator system is as follows.

When the single actuator system is used, the stylus 57 engraves each dot in a target row while moving in the X-axis direction (row direction) of the target row without displacing in the Y-axis direction (column direction). Namely, the stylus 57 engraves the target row on the fixed line while varying engraving depth to express gradation. Accordingly, density of a binary image is expressed at a center in the column direction of each dot even if the density in each dot is varied in the column direction. This limits on the resolution in the column direction.

In contrast, the double actuator system of the vibration actuators SAZ and SAY improves the resolution in the column direction based on the addition of the vibration in the Y-axis direction.

In FIG. 19, a relation between engravings and signals in one dot is illustrated. 0-1 are assigned to “a” and “b” in FIG. 19. The image data may have multi gradations such as 256 gradations. The column of “signal” in FIG. 19 indicates engravable minimum units of colors (black, gray and white). Any one of the minimum units is separately processed in each of upper and lower columns in one dot.

The column of “a” in FIG. 19 indicates a black and white level of the signal for the upper column in one dot. 0 is black and 1 is white. The column of “b” in FIG. 19 indicates a black and white level of the signal for the lower column in one dot. 0 is black and 1 is white. The column of “a+b” in FIG. 19 indicates engraving depth in one dot. 0 is no engraving and 1 is the deepest engraving. For the engraving depth, the vibration actuator SAZ is operated. The column of “a-b” in FIG. 19 indicates displacement of the engraving in one dot. 0 is a center position, +1 is an uppermost position and −1 is a lowermost position. For the displacement, the vibration actuator SAY is operated.

Engravings are, therefore, performed as illustrated in FIG. 20B according to signals of FIG. 20A. For example, if a signal is (0, 0) indicating black for each of the upper and the lower columns in one dot (the first column of the upper row in FIG. 20A), a command is (0, 0) indicating no engraving and no displacement (the first column of the upper row in FIG. 20B). If a signal is (1, 0) indicating white for the upper column and black for the lower column (the second column of the upper row in FIG. 20A), a command is (1, 1) indicating engraving depth being 1 and displacement being 1. Namely, the upper column of one dot is engraved with the engraving depth of 1 (the second column of the upper row in FIG. 20B). The same holds for the third column of the upper row and the first to third columns of the lower row of the FIGS. 20A and 20B.

In this way, the adder circuit 133 and the subtraction circuit 135 are operated to distribute commands according to the displacement of the density in each dot of the image data. With this, the vibration actuators SAZ and SAY are operated to control the position and the engraving depth of the stylus 57 in each dot. This improves the resolution in the column direction.

In addition, the stylus 57 may protrude to an adjoining dot in the column direction if the stylus 57 is displaced within each dot in the column direction. In this case, the displacement of the stylus 57 should be canceled to prevent the stylus 57 from protruding to the adjoining dot. Even if the displacement is not canceled, however, the protrusion of the stylus 57 to the adjoining dot may be ignored for accuracy of the engraved image.

In this way, the double actuator system obtains the precisely engraved image. This principle of the reference example is also applied to the embodiment.

The vibration actuators SAZ and SAY using the solenoids, however, support the movable pieces 147 on the yokes 145 through the springs 149 to output vibrations. This limits on precisely driving the stylus according to remaining vibration and resonances of the springs when switching the energization to the coils 141, to affect accuracy of the engraved image.

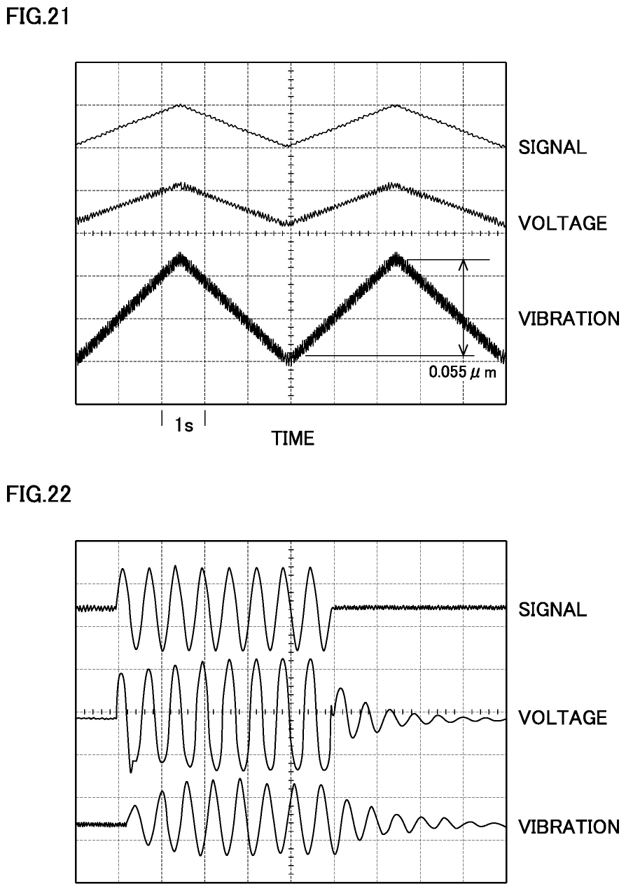

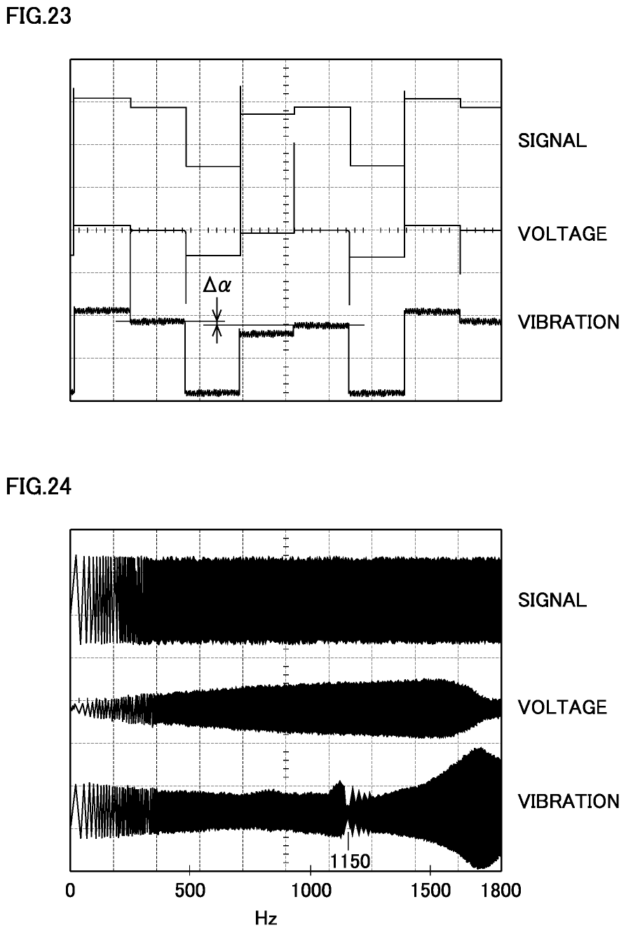

FIG. 21 is a graph illustrating characteristics indicated by triangular waves of a result of a vibration test conducted to the single vibration actuator according to the reference example. FIG. 22 is a graph illustrating characteristics indicated by burst waves of the same. FIG. 23 is a graph illustrating hysteresis characteristics of the same. FIG. 24 is a graph illustrating resonance characteristics of the same.

As illustrated in FIG. 21, amplitude of the vibration of each vibration actuators SAZ and SAY is 55 μm. As illustrated in FIG. 22, a waveform of the vibration of each vibration actuators SAZ and SAY includes a remaining wave based on the springs 149 even after a drive signal is disappeared. Further, as illustrated in FIG. 23, positions of the vibrating stylus 57 has no precisely repeatability according to hysteresis and involves difference Act. Further, as illustrated in FIG. 24, resonance is generated by the springs 149 in each of the vibration actuators SAZ and SAY.

In this way, there is a limit to precisely driving of the stylus 57 using the vibration actuators SAZ and SAY with the solenoids according to the influence of the springs 149 supporting the movable piece 147.

In contrast, the vibration actuators PAZ and PAY using the piezoelectric elements according to the embodiment precisely drives the stylus 57 without large springs to support a movable piece, thereby to perform the engraving with high accuracy.

What is claimed is:

1. An image engraving apparatus, comprising:
a floating base elastically supported;
a vibration actuator fixed to the floating base and including an output portion and stacked piezoelectric elements, the output portion configured to output vibration generated by deformation of the piezoelectric elements;
a stylus holder connected to the output portion to receive the vibration;
a stylus supported with the stylus holder to be vibrated according to the vibration received by the stylus holder and engrave an image on a medium to be engraved;
a supporting spring supporting the stylus holder to the floating base to allow the stylus holder to be vibrated when the stylus holder receives the vibration; and
a retainer positionally adjustably supported to the floating base to come into contact with the medium to be engraved and position the stylus relatively to the medium to be engraved, wherein
relative movement between the stylus vibrated and the medium to be engraved is caused based on an image signal to engrave an image on the medium to be engraved.

2. The image engraving apparatus according to claim 1, wherein
the floating base is elastically supported in a Z-axis direction,
the vibration actuator includes a Z-axis vibration actuator and a Y-axis vibration actuator, the Z-axis vibration actuator having a Z-axis output portion to output vibration in the Z-axis direction, and the Y-axis vibration actuator having a Y-axis output portion to output vibration in a Y-axis direction,
the stylus holder is connected to the Z-axis output portion and the Y-axis output portion to receive the vibrations in the Z-axis direction and the Y-axis direction, and
the supporting spring includes a Z-axis spring portion to allow the stylus holder to be vibrated in the Z-axis direction and a Y-axis spring portion to allow the stylus holder to be vibrated in the Y-axis direction.

3. An engraving head comprising:
a head frame supported on an apparatus body through a Z-axis driving mechanism to vertically move in a Z-axis direction;
a floating base elastically supported to the head frame in the Z-axis direction;
a Z-axis vibration actuator fixed to the floating base and having a Z-axis output portion and stacked piezoelectric elements, the Z-axis output portion configured to output vibration generated by deformation of the piezoelectric elements of the Z-axis vibration actuator in the Z-axis direction;
a Y-axis vibration actuator fixed to the floating base and having a Y-axis output portion and stacked piezoelectric elements, the Y-axis output portion configured to output vibration generated by deformation of the piezoelectric elements of the Y-axis vibration actuator in the Y-axis direction;
a stylus holder connected to the Z-axis output portion and the Y-axis output portion to receive the vibrations in the Z-axis direction and the Y-axis direction;
a stylus supported with the stylus holder to be vibrated according to the vibration received by the stylus holder and engrave an image on a medium to be engraved;
a supporting spring supporting the stylus holder to the floating base and including a Z-axis spring portion to allow the stylus holder to be vibrated in the Z-axis direction when the stylus holder receives the vibration in the Z-axis direction and a Y-axis spring portion to allow the stylus holder to be vibrated in the Y-axis direction when the stylus holder receives the vibration in the Y-axis direction; and
a retainer positionally adjustably supported to the floating base to come into contact with the medium to be engraved and position the stylus relatively to the medium to be engraved, wherein
relative movement between the stylus vibrated and the medium to be engraved is caused based on an image signal to engrave an image on the medium to be engraved.

4. The engraving head according to claim 3, wherein
the supporting spring is formed in a single body,
the Z-axis spring portion is connected to the stylus holder, and
the Y-axis spring portion is connected to the floating base.

5. The engraving head according to claim 3, wherein
the Z-axis vibration actuator is formed into a flat shape along the Z-axis direction,
the Y-axis vibration actuator is formed into a flat shape along the Y-axis direction, and
the Z-axis and the Y-axis vibration actuators are fixed to the floating base through positioning brackets, respectively.
